(19) United States
(12) Patent Application Publication
(10) Pub. No.: US 2014/0154425 A1
(43) Pub. Date: Jun. 5, 2014

(54) METHOD FOR INCREASING THE ADHESIVE POWER OF A PRESSURE-SENSITIVE ADHESIVE LAYER HAVING AN UPPER AND A LOWER SURFACE

(71) Applicants: Hermann Neuhaus-Steinmetz, Ahrensburg (DE); Uwe Schümann, Pinneberg (DE); Arne Koops, Neu-Lankau (DE); Thomas Schubert, Hamburg (DE); Olga Kirpicenok, Hamburg (DE); Kirstin Weiland, Hamburg (DE); Dennis Perlbach, Neu Wulmstorf (DE); Sarah Reich, Hamburg (DE)

(72) Inventors: Hermann Neuhaus-Steinmetz, Ahrensburg (DE); Uwe Schümann, Pinneberg (DE); Arne Koops, Neu-Lankau (DE); Thomas Schubert, Hamburg (DE); Olga Kirpicenok, Hamburg (DE); Kirstin Weiland, Hamburg (DE); Dennis Perlbach, Neu Wulmstorf (DE); Sarah Reich, Hamburg (DE)

(73) Assignee: TESA SE, Hamburg (DE)

(21) Appl. No.: 14/115,903

(22) PCT Filed: May 4, 2012
(86) PCT No.: PCT/EP2012/058282

§ 371 Date: Jan. 31, 2014

(30) Foreign Application Priority Data
May 6, 2011 (DE) 10 2011 075 468.7

(51) Int. Cl. C09J 5/00

(52) U.S. Cl. CPC C09J 5/00
USPC 427/535; 427/540; 219/773; 432/9; 34/444; 250/324

(57) ABSTRACT

Method for increasing the adhesive power of a pressure-sensitive adhesive layer having an upper and a lower surface, wherein at least one surface of the pressure-sensitive adhesive layer is subjected to a physical process, said physical process being selected from among the group comprising corona discharge, dielectric barrier discharge, preliminary flame treatment, or plasma treatment.

The invention pertains to a method for increasing the bond strength of a layer of pressure-sensitive adhesive (PSA) having a top and a bottom surface.

A feature of substances with viscoelastic properties suitable for pressure-sensitive adhesive applications is that under mechanical deformation they not only exhibit viscous flow but also develop elastic resilience forces. In terms of their respective proportion, the two processes stand in a certain ratio to one another, dependent not only on the precise composition, the structure, and the degree of crosslinking of the substance in question, but also on the rate and duration of the deformation, and on the temperature.

In order to achieve sufficient cohesion in the PSAs of the adhesive tapes, the PSAs are generally crosslinked, meaning that the individual macromolecules are linked to one another through bridging bonds. Crosslinking may take place in a variety of ways—for instance, there are physical, chemical, or thermal crosslinking methods.

The proportional viscous flow is needed for the attainment of adhesion. Only the viscous components, brought about by means of macromolecules with relatively high mobility, permit effective wetting and good flow onto the substrate that is to be bonded. A high proportion of viscous flow leads to a high inherent tackiness (also referred to as pressure-sensitive adhesiveness or as tack) and hence often also to a high bond strength. Owing to a lack of fluid components, inherent tack is generally not a feature of highly crosslinked systems or of polymers which are crystalline or have undergone glasslike solidification.

The proportional elastic resilience forces are necessary for the attainment of cohesion. They are brought about, for example, by very long-chain macromolecules which are very highly interentangled and also are crosslinked physically or chemically, and they permit the transmission of the forces that act on an adhesive bond. These forces allow an adhesive bond to adequately withstand, over a relatively long period of time, a sustained load acting on it, in the form of a sustained shearing load, for example.

In order to prevent the PSAs flowing off (running down) from the substrate, and in order to guarantee sufficient stability of the PSA within the bonded assembly, then, sufficient cohesion on the part of the PSAs is a requirement. For effective adhesion properties, moreover, the PSAs must be in a position to flow onto the substrate and to guarantee sufficient wetting of the substrate surface. In order to prevent fractures within the bonded joint (within the PSA layer), moreover, a certain elasticity in the PSA is required.

Moreover, not only the wetting of the surface but also the nature of the interaction is important for adhesion, in other words the specific energy of interaction of the interfaces between adhesive and substrate. This is dominated by the chemical nature of the surfaces. PSAs here must overcome a conflict between their rheology, i.e., the properties of their volume, and their adhesiveness, i.e., a mixture of volume properties and surface properties.

For use, for example, in the automobile and electronics industries, self-adhesive tapes are subject to exacting performance requirements. Important criteria here include good bonding strength, in particular a high shear strength, high aging resistance, and, not least, electronic compatibility. For corresponding applications, therefore, self-adhesive tapes based on highly crosslinked polyacrylate adhesives are principally utilized. Double-sidedly adhering adhesive tapes are very often utilized for the usually permanent joining of components.

Double-sidedly adhering self-adhesives tapes of this kind are used diversely in the fixing and joining of a very wide variety of materials. For instance, presently, a multiplicity of different self-adhesive tapes are in use in the automobile industry, for the bonding of door trim and decorative trim, and in the electronics industry, for the bonding of displays, batteries, or loudspeakers in devices including cell phones, digital cameras, or pocket computers, for example. Through the use of pressure-sensitive adhesive tapes it is possible for the individual technical components to be mounted in a more space-saving way which is significantly quicker and hence is more efficient and cost-effective.

For diverse applications, as in the construction sector, in the industrial manufacture of technical products, or for assembly purposes, for example, there is a need for increasingly thick yet strongly bonding adhesive tapes. Since the adhesive bonds often take place in the outdoor area and/or the bonded products are exposed to the effects of outdoor weathering, the expectations of the properties of such adhesive tapes are frequently high: accordingly, the adhesive bond is to be strong, durable, and weather-resistant; frequent requirements include high moisture resistance, heat stability, and resistance to heat and humidity combined; the adhesive tapes ought advantageously to be able to compensate for unevennesses in the bondline and/or on the substrates to which bonding is to take place, and also, increasingly, for thick adhesive tapes, high transparency is desired (for instance in the area of the bonding of transparent materials such as glasses or transparent polymers). Here as well the use of highly crosslinked polyacrylate adhesives is customary.

The adhesive tapes employed for such purposes are commonly furnished with adhesives in which the technical adhesive properties have to be particularly effectively balanced. For instance, cohesion, contact tackiness (also referred to as “tack”), flow behavior, and other properties must be very precisely adjusted. Since the technical shaping operations on the PSA, which influence these properties, often have divergent consequences on the individual properties, finding a balance is generally difficult, or compromises must be accepted in the outcome. For example, it is a problem for adhesives possessing particular shear strength to be optimized for adhesion as well.

The problems of the deficient adhesion of highly crosslinked acrylate adhesives is also manifested, for example, in the lamination of multi-ply adhesive tapes. Such lamination works very well with noncrosslinked PSAs, such as adhesives based on polyisobutylene, physically crosslinked PSAs such as adhesives based on styrene block copolymers, especially if this lamination takes place at elevated temperature, or PSAs with low degrees of crosslinking, such as adhesives based on natural rubber with a low degree of crosslinking, for example. The lamination of crosslinked acrylate PSA layers, in contrast, frequently results in a laminate having a diminished profile of properties, owing to low lamination strength or composite strength of the layers. It is thought that, owing to a high degree of crosslinking, the polymer chains in the acrylate PSA are incapable of forming interloops of sufficient length at the interface. With certain products, indeed, this circumstance is in fact utilized in order to supply a double-sided self-adhesive tape in the form of a roll without release material (release paper or release sheet), so that two plies of the polyacrylate PSA layer are in long-term direct contact. Even after years of storage, these products can still be unwound with no problems. tesafix® 56661 is one example of such a product.

For the segment of high-performance adhesive tapes and adhesive assembly tapes in particular, there are carrier-free, viscoelastic adhesive tapes. “Carrier-free” in this context means that no layer is needed for structural cohesion, and so the adhesive tape is inherently sufficiently cohesive for the specified use. It is unnecessary to use a carrier sheet or the like, such as woven or nonwoven fabric. These adhesive tapes are also based mostly on highly crosslinked acrylate adhesives. Moreover, these pressure-sensitive adhesive tapes are usually relatively thick, typically above 300 μm.

A thus-designated viscoelastic polymer layer may be regarded as a fluid of very high viscosity, which exhibits flow (also referred to as “creep”) behavior under a pressure load. Such viscoelastic polymers or such a polymer layer possess or possesses to a particular degree the capacity, under slow exposure to force, to relax the forces which act on them/it: they are capable of dissipating the forces into vibrations and/or deformations (which more particularly may also—at least partly—be reversible), and thus of “buffering” the acting forces, and preferably avoiding mechanical destruction by the acting forces, but advantageously at least reducing such mechanical destruction or else at least delaying the time of the occurrence of destruction. In the case of a force which acts very quickly, viscoelastic polymers customarily exhibit an elastic behavior, in other words the behavior of a fully reversible deformation, and forces which exceed the elasticity of the polymers may cause a fracture. In contrast to this are elastic materials, which exhibit the described elastic behavior even under slow exposure to force. By means of admixtures, fillers, foaming, or the like, it is also possible for such viscoelastic adhesives to be varied greatly in their properties.

Owing to the elastic components of the viscoelastic polymer layer, which in turn make a substantial contribution to the technical adhesive properties of adhesive tapes featuring such a viscoelastic carrier layer, it is not possible for the tension, for example, of a tensile or shearing stress to be relaxed completely. This fact is expressed through the relaxation capacity, which is defined as ((stress(t=0)—stress(t)/stress (t=0))*100%. Viscoelastic carrier layers typically display a relaxation capacity of more than 50%.

Although any adhesive is viscoelastic in nature, for carrier-free high-performance adhesive tapes the use is preferred of adhesives which display these particular relaxation qualities.

In the development of adhesives, the achievement of these particular relaxation qualities with retention of high cohesion often leads to compromises with low adhesion and a reduced bond strength as a result. On account of the high level of cohesion that is needed, it is by no means a trivial matter to produce carrier-free, viscoelastic adhesive tapes that possess high shear strength and feature high adhesion and/or tack. It is found that without the use of tackifying resins, as are otherwise customary in the case of adhesives, the adhesion often remains insufficient. The admixing of such resins, as any skilled person is aware, comes at the cost of the shear strength—for high-performance applications, however, such detriment to shear strength must absolutely be avoided.

The transition to “conventional” adhesives, however, is fundamentally a fluid one, especially to adhesive transfer tapes, and hence also to adhesives which are typically employed with carriers. For example, there is nothing against an adhesive identified as being especially “viscoelastic” being used also, in a thin layer, in a conventional adhesive tape with carrier. Conversely, a “conventional” adhesive may also be rational in certain cases in a thick-layer product, or may be optimized sufficiently for a defined purpose by means of admixtures, fillers, foaming, or the like.

In the case of many adhesive bonds on real-life surfaces, moreover, it is in practice often necessary to apply an adhesion promoter, also called primer, to the surface. If the surface is contaminated with dirt or oil, a primer, together with cleaning or physical pretreatment of the surface, may permit adequate adhesive bonding. For a physical surface treatment, plasma systems are generally employed, often in nozzle geometry and at atmospheric pressure. The use of a primer is usually undesirable, for reasons of complexity and of the difficulties of application.

In certain cases in the past it has been possible to show the improvement of some surface properties of a PSA through “activation” of its surface. Which particular properties these are, and the manifestation of any such improvement, may differ very greatly.

In this invention, the term “activation” is used as a synonym for all versions of modification which relate only to the surface and have a positive influence over the adhesion properties. Contemplated primarily for such versions are physical methods such as corona, plasma, and flame. The term “activation” generally implies a nonspecific modification. Very predominantly only the bonding base/substrate is treated, and not the (pressure-sensitive) adhesive. In principle there is already prior art on the activation of adhesive surfaces, but this prior art is not particularly comprehensive.

DE 10 2007 063 021 A1 describes the corona activation of adhesives for the purpose of increasing the holding powers. Described more particularly is the problem that in the case of UV-crosslinked PSAs there is a crosslinking profile with increased crosslinking near to the interface, with adhesion reduced as a result. The teaching is to boost the shear strength by means of a corona treatment, with technical adhesive properties that are otherwise virtually unchanged, including unchanged or even reduced bond strength. To the skilled person it is clear that increasing the HP does not also, trivially, produce an increase in the bond strength.

The teaching of DE 10 2006 057 800 A1, moreover, is of how, through activation of adhesive surfaces prior to lamination, an increase in the shear strength is achieved in a multi-ply adhesive tape. The treatment takes place on interfaces within the product, and serves to increase the interlaminate adhesion. No increase in the bond strength of the adhesive tape taught is demonstrated.

The solutions taught to date in the prior art for increasing the bond strength of a shaped viscoelastic pressure-sensitive adhesive layer relate to the additional lamination of one or more layers of an adhesive, to produce a multilayer construction.

WO 2006/027389 A1 teaches one such multilayer construction, with the individual layers advantageously being corona-treated. A three-layer construction is described, composed of layers each with a bond strength of less than 10 N/cm, more particularly below 7 N/cm, although the three-layer construction has a bond strength of greater than 10 N/cm.

The obvious disadvantages of a multilayer construction are the increased manufacturing cost and complexity, and the number of operating steps. With this kind of solution, in principle, delamination problems between the layers may arise, since the interlaminate adhesion derives not from strong covalent chemical interactions but instead from unspecific interactions of a general polar kind.

Improving the interlaminate adhesion in a multilayer construction of this kind with a viscoelastic carrier is described in EP 2 062 951 A1, where the effect of a corona treatment on the surface of the adhesive is combined with the chemical after-reactions of a thermal crosslinking. However, the disadvantages of the increased complexity of a multilayer construction, as described above, still remain. Moreover, it is impossible to rule out the properties of the laminated-on adhesive as well being adversely altered by postcrosslinking reactions as a result of diffusion of the crosslinker employed.

The object of this invention is to specify a method with which the bond strength of a PSA layer can be increased. This object is to be achieved more particularly for viscoelastic, carrier-free pressure-sensitive adhesive tapes with high technical adhesive requirements particularly as regards the shear strength. A further object is to provide a double-sidedly adhesive tape which as a result of physical treatment possesses unequal bond strengths (“graduated”) on the two sides. Moreover, the intention is to provide an adhesive tape which through physical treatment of its surface, even without application of a primer to the substrate, attains such high adhesion or bond strength that cohesive rather than adhesive failure occurs when the adhesive tape is removed (in fracture tests or peel tests, for example).

These objects are achieved by means of a method as set out in the main claim. The dependent claims provide advantageous developments of the method.

The invention accordingly provides a method for increasing the bond strength of a layer of pressure-sensitive adhesive (PSA) having a top and a bottom surface, the PSA layer being subjected at least on one surface side to a physical method, the physical method being selected from the group consisting of corona discharge, dielectric barrier discharge, flame pretreatment, and plasma treatment.

According to a further advantageous embodiment, both surfaces of the PSA layer are subjected to a physical method.

The stated objects are therefore achieved by physical treatment of the surface of the adhesive, more particularly a plasma treatment, in other words by a defined modification of the interface without a change in the volume properties. A double-sidedly adhesive tape is provided which, without further layers being laminated on, possesses an enhanced bond strength.

A particularly preferred physical method is a plasma treatment at or close to atmospheric pressure. By “close to” here is meant a deviation of a few percent from atmospheric pressure (upward or downward), more particularly less than 10%, preferably less than 5%, more preferably less than 2%.

This enhanced bond strength exceeds that which would have been expected from the rheological properties and/or volume properties. As the skilled person is aware, bond strength values measured on an absolute basis differ greatly as a result of thickness, time of application, applied pressure, etc. For the purposes of this invention, therefore, an enhancement of the bond strength is seen not in the sense of an absolute value, such as in N/cm, for example, but instead in relation to a comparable untreated surface. Especially useful is a “before/after” ratio of the bond strengths of the same surface. The enhancement of the bond strength for the purposes of this invention is significant, typically more than 20%.

Even with very polar adhesives, surprisingly, an enhancement to the bond strength after physical pretreatment is observed. For instance, even in the case of a straight acrylate adhesive with an acrylic acid fraction of 12 wt. %, a significant enhancement to the bond strength can be observed. Also surprising is the enhancement to the bond strength of resin-blended adhesives as a result of a physical pretreatment. Despite a resin fraction of 30% or more, a significant enhancement to the bond strength can be observed. It has also been surprisingly found that the bond strength was enhanceable with respect both to high-energy substrates (such as steel) and to low-energy substrates (such as polyethylene).

Hence it is possible to provide an adhesive tape which by virtue of physical pretreatment possesses a bond strength enhanced in relation to a diversity of substrates. More particularly it is possible to provide a double-sidedly adhesive tape with graduated bond strengths on the open side and the lined side, without further layers being laminated on.

Graduated bond strengths, or an adhesive tape with graduated bond strengths, are of interest, for example, for an application where deliberate opening of an adhesive bond above a defined force threshold is desired. In the case of specific detachment or opening of a bond, it is then also possible to ensure that the layers of adhesive remain on the desired substrates. In any given case, an arbitrarily low graduation may be useful.

A physical method for the purposes of this invention is a method which generates a plasma through electrical discharges, and exposes the substrate to be treated to this plasma.

In the sense of this invention, the treatment takes place under a pressure which is close to or at atmospheric pressure. The average electron velocity in the plasma is usually very high, with its average kinetic energy much higher than that of the ions. Accordingly, an electron temperature defined by way of this energy is different from the temperature of the ions, and the plasma is not at thermal equilibrium: it is “cold”.

The physical pretreatment technique usually referred to as “corona” is usually a “dielectric barrier discharge” (DBD). In this regard, see also Wagner et al., Vacuum, 71 (2003), 417-436. It involves the substrate to be treated being passed in web form between two high-voltage electrodes, at least one electrode consisting of a dielectric material or being coated with such material. The intensity of a corona treatment is stated as the “dose” in [Wmin/m²], with the dose D=P/b*v, with P=electrical power [W], b=electrode breadth [m], and v=web speed [m/min].

By means of a suitably high web tension, the substrate is pressed onto the counterelectrode, configured as a roll, in order to prevent air inclusions. The treatment distance is typically about 1 to 2 mm. A fundamental disadvantage of a two-electrode geometry of this kind, with a treatment in the space between electrode and counterelectrode, is the possible reverse-face treatment. In the event of very small inclusions of air or gas on the reverse face, as for example if the web tension is too low in the case of roll-to-roll treatment, there is a usually unwanted corona treatment of the reverse face.

In the case of treatment with high-frequency alternating voltage in the kV range, discrete discharge channels briefly come about between electrode and substrate, and accelerated electrons also strike the surface of the substrate. When the electrons strike, the energy may amount to two to three times the bond energy of the usual molecular bonds of a plastics substrate, and may therefore break said substrate open. Secondary reactions give rise to functional and polar groups in the surface. The formation of polar groups makes a strong contribution, for example, to raising the surface energy. As a result of the action of the high-energy accelerated electrons, a treatment of this kind is very efficient in respect of the electrical energy used, and very powerful, based on the possible reactions initiated. The generation of a high density of polar and functional groups, however, is in competition with the degradation of material through chain breakages and oxidation.

The simple corona treatment or DBD is used customarily for the treatment of nonpolar surfaces and films, so that their surface energy and wettability increases. For instance, polymeric films are often subjected to corona treatment prior to printing or to the application of adhesives.

Although, in a wider sense, corona treatment in air is a technique in which plasma plays a part, a narrower definition is customarily understood for a plasma treatment at atmospheric pressure.

If a corona treatment takes place in a gas mixture other than air, such as one based on nitrogen, for example, plasma is already relevant in part. In the narrower sense, however, an atmospheric-pressure plasma treatment is a homogeneous and discharge-free treatment. A homogeneous plasma of this kind can be generated, for example, by using noble gases, in some cases with admixtures. This treatment takes place in a two-dimensional reaction space filled homogeneously with plasma.

The reactive plasma comprises radicals and free electrons which are able to react rapidly with numerous chemical groups in the substrate surface. This leads to the formation of gaseous reaction products and highly reactive free radicals in the surface. Through secondary reactions, these free radicals are able to undergo further reaction rapidly with oxygen or other gases, and form various chemical functional groups on the substrate surface. As with all plasma techniques, the generation of functional groups is in competition with degradation of the material.

The substrate to be treated may also be exposed not to the reaction space of a two-electrode geometry but instead only to the discharge-free plasma (“indirect” plasma). In that case, in good approximation, the plasma is also usually free of potential. The plasma is expelled from the discharge zone usually by a stream of gas and, after a short section, is conveyed onto the substrate, without the need for a counterelectrode. The lifetime (and hence also the useful section) of the reactive plasma, often called “afterglow”, is determined by the precise details of the recombination reactions and the plasma chemistry. The reactivity is usually observed to decline exponentially with the distance from the discharge source.

Modern indirect plasma techniques are often based on a nozzle principle. The nozzle here may be of round or linear configuration; in some cases, rotary nozzles are operated—there is no desire here to impose a restriction. A nozzle principle of this kind is advantageous on account of its flexibility and its inherently single-sided treatment. Such nozzles, from the company Plasmatreat, for example, are widespread in industry for the pretreatment of substrates prior to adhesive bonding. A disadvantage is the indirect treatment, which, being discharge-free, is less efficient, and hence the reduced web speeds are a disadvantage. The customary constructional form of a round nozzle, however, is especially suitable for treating narrow webs of products, such as an adhesive tape with a breadth of a few cm, for example.

There are a variety of plasma generators on the market, differing in the plasma generation technology, the nozzle geometry, and the gas atmosphere. Although the treatments differ in factors including the efficiency, the fundamental effects are usually similar and are determined above all by the gas atmosphere employed. Plasma treatment may take place in a variety of atmospheres, and the atmosphere may also include air. The treatment atmosphere may be a mixture of different gases, selected inter alia from N₂, O₂, H₂, CO₂, Ar, He, ammonia, it also being possible for steam or other constituents to have been admixed. This exemplary recitation does not impose any restriction.

In principle it is also possible to admix the atmosphere with coating or polymerizing constituents, in the form of gas (ethylene for example) or liquids (in atomized form as aerosol). There is virtually no restriction to the aerosols that are suitable. The indirectly operating plasma techniques in particular are suitable for the use of aerosols, since there is no risk of fouling of the electrodes.

Since the effects of a plasma treatment are of chemical nature and the focus is on changing the surface chemistry, the methods described above may also be described as chemico-physical treatment methods.

In principle, then, it is surprising to the skilled person that through the treatment of the surface of an adhesive by a physical or chemico-physical method it is possible to achieve an enhancement in the bond strength. Since the skilled person expects all of these methods to entail chain breakages and degradation of material, the anticipated result would be formation of a layer with a high polar group content but a low internal cohesion. As a result of the weakly cohesive layer with increased polarity, improved wetting of the substrate by the adhesive is not surprising, but reduced adhesion properties are expected. To be seen in this context is the fact, for example, that in DE 10 2006 057 800 A1 there is no enhancement to bond strength taught through corona treatment of the surface of an adhesive.

For the skilled person it is surprising, moreover, that in the event of treatment of the surface of an adhesive with an indirect plasma, an effect can be achieved, i.e., an increase in the bond strength, which is comparable with, or even exceeds, a corona treatment.

Surprisingly, a suitable plasma treatment of the adhesive prior to application may even render the use of an adhesion promoter or primer superfluous. The abandonment of primer is advantageous on a number of grounds, primarily those of reduced complexity and cost.

In the sense of this invention, however, it is also possible to subject the bond substrate to a physical treatment as well. Such treatment may serve to clean the substrate, but especially and additionally to generate a specific surface modification which serves for a further boost in the bond strength. The pretreatment need not necessarily be the same as is used for the adhesive tape. Thus, for example, the adhesive tape may be subjected to treatment with a nitrogen plasma, and the substrate, steel for example, is subjected to treatment with an oxygen plasma. Both treatments may be performed advantageously with an indirect nozzle technique.

The adhesive tapes with bond strength enhanced by physical treatment in the sense of this invention are suitable for uses including in permanent adhesive bonds, especially high-performance applications and assembly applications.

These adhesive tapes, however, are also suitable for further processing, as for example for use in a multilayer construction, a laminate, or another product or component.

The sense of this invention does not rule out the advantageous utilization of the bond strength increased by physical treatment also in the context of an adhesive bond on soft, elastic, or self-adhesive substrates. Also not ruled out here are laminates or multilayer constructions of a pressure-sensitive adhesive tape, if the bond strength increased as a result between the layers, as measurable, for example, in a release force test, is advantageous.

The PSA layer is based preferably on natural rubber, synthetic rubber, or polyurethanes, the PSA layer consisting preferably of pure acrylate or predominantly of acrylate.

For the purpose of improving the adhesive properties, the PSA may have been blended with tackifiers.

Tackifiers, also referred to as tackifying resins, that are suitable, in principle, are all known classes of compound. Tackifiers are, for example, hydrocarbon resins (for example, polymers based on unsaturated C₅ or C₉ monomers), terpene-phenolic resins, polyterpene resins based on raw materials such as, for example, α- or β-pinene, aromatic resins such as coumarone-indene resins or resins based on styrene or α-methylstyrene such as rosin and its derivatives, as for example disproportionated, dimerized, or esterified rosin, examples being reaction products with glycol, glycerol, or pentaerythritol, to name but a few. Preferred resins are those without easily oxidizable double bonds, such as terpene-phenolic resins, aromatic resins, and, more preferably, resins prepared by hydrogenation, such as, for example, hydrogenated aromatic resins, hydrogenated polycyclopentadiene resins, hydrogenated rosin derivatives, or hydrogenated polyterpene resins. Preferred resins are those based on terpene-phenols and rosin esters. Likewise preferred are tackifying resins having a softening point of more than 80° C. to ASTM E28-99 (2009). Particularly preferred resins are those based on terpene-phenols and rosin esters with a softening point above 90° C. to ASTM E28-99 (2009). Typical amounts for use are 10 to 100 parts by weight, based on polymers of the adhesive.

For further improvement in the cable compatibility, the adhesive formulation may optionally have been blended with light stabilizers or primary and/or secondary aging inhibitors. Aging inhibitors used may be products based on sterically hindered phenols, phosphites, thiosynergists, sterically hindered amines, or UV absorbers. Used with preference are primary antioxidants such as, for example, Irganox 1010 (tetrakis(methylene(3,5-di(tert)-butyl-4-hydrocinnamate))methane; CAS No. 6683-19-8 (sterically hindered phenol), BASF), or Irganox 254, alone or in combination with secondary antioxidants such as, for example, Irgafos TNPP or Irgafos 168.

The aging inhibitors can be used in any desired combination with one another, with mixtures of primary and secondary antioxidants in combination with light stabilizers such as, for example, Tinuvin 213 displaying particularly good aging inhibition effect.

Having proven especially advantageous are aging inhibitors in which a primary antioxidant is combined with a secondary antioxidant in one molecule. These aging inhibitors are cresol derivatives whose aromatic ring is substituted at two arbitrary, different locations, preferably in ortho- and meta-positions to the OH group, by thioalkyl chains, it also being possible for the sulfur atom to be joined to the aromatic ring of the cresol building block via one or more alkyl chains. The number of carbon atoms between the aromatic system and the sulfur atom may be between 1 and 10, preferably between 1 and 4. The number of carbon atoms in the alkyl side chain may be between 1 and 25, preferably between 6 and 16. Particularly preferred in this context are compounds of the type of 4,6-bis(dodecylthiomethyl)-o-cresol, 4,6-bis(undecylthiomethyl)-o-cresol, 4,6-bis(decylthiomethyl)-o-cresol, 4,6-bis(nonylthiomethyl)-o-cresol or 4,6-bis(octylthio-methyl)-o-cresol. Aging inhibitors of this kind are available for example from Ciba Geigy under the name Irganox 1726 or Irganox 1520.

The amount of aging inhibitor added or of aging inhibitor package added ought to be located within a range between 0.1 and 10 wt %, preferably in a range between 0.2 and 5 wt %, more preferably in a range between 0.5 and 3 wt %, based on the total solids content.

For improving the processing properties, the adhesive formulation may additionally have been blended with customary process auxiliaries such as defoamers, deaerating agents, wetting agents, or flow control agents. Suitable concentrations are in the range from 0.1 up to 5 parts by weight, based on the solids.

Fillers (reinforcing or nonreinforcing) such as silicon dioxides (spherical, acicular, lamellar, or irregular such as the pyrogenic silicas), glass in the form of solid or hollow beads, microballoons, calcium carbonates, zinc oxides, titanium dioxides, aluminum oxides, or aluminum oxide hydroxides may serve both for adjusting the processing properties and also the technical adhesive properties. Suitable concentrations are in the range from 0.1 up to 20 parts by weight, based on the solids. Microballoons particularly are preferred, since they allow foaming of the adhesive.

One advantageous version of the invention, then, is a single-layer, double-sidedly adhesive, carrier-free, straight acrylate adhesive tape, in one particularly simple construction consisting of a layer of a viscoelastic adhesive (for example by method VP) with a thickness of 300 μm. This adhesive tape has been pretreated on one side by a physical method, preferably an indirect plasma treatment in air, and has a graduated bond strength. This version of the adhesive tape and the method for producing it are of very low complexity, and the adhesive tape has a bond strength which is higher than would be achievable by rheological optimization of the adhesive.

Particularly advantageous is the treatment of both sides by a physical method, for optimization for the particular bond substrates.

Also particularly advantageous is the production of an adhesive tape of this kind in a thickness greater than 1000 μm.

Another advantageous version, however, is the production of a double-sidedly adhesive, relatively thin adhesive tape composed of a conventional acrylate adhesive (for example, 50 g/m², by method PA) without a carrier, typically referred to as an adhesive transfer tape. This advantageous adhesive tape is coated from solvents on a release liner and is treated by plasma on one side, prior to application, for the purpose of boosting the bond strength.

Another advantageous version as well, however, is the production of a single-sidedly adhesive tape with a film carrier (for example, adhesive coatweight 50 g/m², by method PA, on a 20 μm PET carrier) which is plasma-treated on one side before application for the purpose of boosting the bond strength.

Another advantageous version as well, however, is the production of a double-sidedly adhesive tape with a film carrier, coated on both sides with adhesive (for example, adhesive coatweight 50 g/m², by method PA). This double-sidedly adhesive tape is plasma-treated on one or both sides to enhance the bond strength, depending on the desired bond-strength optimization.

Another particularly advantageous version as well, however, is the production of a double-sidedly adhesive tape with a foam carrier, coated on both sides with adhesive (for example, adhesive coatweight 50 g/m², by method PA). This double-sidedly adhesive foam adhesive tape is treated by plasma on one or both sides for the purpose of boosting the bond strength, depending on the desired bond-strength optimization.

The adhesive tape may be laminated from a plurality of layers, with one or more interfaces being subjected, prior to lamination, to the physical treatment of the invention, followed by physical treatment of at least one adhesive surface of the adhesive tape.

The pressure-sensitive adhesive tape may also be a laminate of two or more layers of PSAs.

In accordance with another advantageous embodiment, the substrate to which the PSA layer is to be bonded has been physically pretreated, the pretreatment of the substrate preferably differing from that of the adhesive.

This bond substrate may be the substrate to which the adhesive is adhered, such as a steel substrate or a substrate made of another metal or of glass or ceramic, for example.

The bond substrate may also be the carrier to which the PSA is applied and which therefore forms the adhesive tape, examples being films of PE, PP, PS, or PET, foams, nonwoven webs, woven fabrics, and also other substrates and composite materials. The adhesive tape may comprise one or more layers of films or foam carriers. The adhesive tape may further comprise one or more functional layers such as barrier layers, layers of hotmeltable material, or other functional layers.

The overall thickness of the adhesive tape is preferably more than 20 μm, more preferably more than 100 μm, very preferably more than 200 μm.

If the adhesive is applied from solvent or as an aqueous dispersion, the physical treatment takes place preferably after a drying operation.

With further preference the physical treatment takes place immediately after the adhesive for treatment has been applied by coating.

Alternatively the treatment may take place after an aging time/at a later point in time, after the adhesive for treatment has been applied by coating, and more particularly may take place immediately prior to adhesive bonding or further processing. However, the treatment may also take place some time before the bonding or further processing. With further preference it has proven useful if the treatment is repeated (“refreshed”) after a certain time.

### Test methods

### Test Method 1 (90° Bond Strength to Steel)

The bond strength to steel is determined under test conditions of 23° C.+/−1° C. temperature and 50%+/−5% relative humidity. The specimens were cut to a breadth of 20 mm and adhered to a steel plate. Prior to the measurement, the steel plate is cleaned and conditioned. This is done by first wiping the plate with acetone and then leaving it to lie in the air for 5 minutes to allow the solvent to evaporate.

Unless otherwise described, the specimens were laminated on an etched PET film 23 μm thick, allowing the PET film to be clamped in for the tensile test. The anchoring of the adhesive to the PET film was always good enough that no delamination from the PET film was ever observed.

The test specimen was applied to the steel substrate and then pressed on 5 times using a 2 kg roller with a rolling speed of 10 m/min. Unless otherwise indicated, this was followed by storage at 40° C. for seven days, with subsequent one-hour reconditioning in the test conditions.

For the measurement, the steel plate was inserted into a special mount which allows the specimen to be pulled off vertically upward at an angle of 90°. The bond strength measurement was made using a Zwick tensile testing machine. The measurement results are reported in N/cm and are averaged from three measurements.

Test method 2 (T-Peel Bond Strength)

The T-peel bond strength is determined under test conditions of 23° C.+/−1° C. temperature and 50%+/−5% relative humidity. Basically a two-layer assembly is produced, and the bond strength (or release force) of this assembly is measured by pulling in a geometry which when viewed from the side resembles a horizontal “T”.

Unless otherwise described, the adhesive specimens were laminated on an etched PET film 23 μm thick, allowing the PET film to be clamped in for the tensile test. The anchoring of the adhesive to the PET film was always good enough that no delamination from the PET film was ever observed. If a substrate was not adhesive, it was clamped in directly.

The two substrates were laminated together by hand to form two-layer specimens, which were cut to a breadth of 20 mm and then pressed on 5 times using a 2 kg roller with a rolling speed of 10 m/min. This was followed by storage at 40° C. for seven days, with subsequent one-hour reconditioning in the test conditions.

For the measurement, both substrates were clamped into one jaw each of a Zwick tensile testing machine, and the “T” formed by the substrate was supported by hand. The measurement results are reported in N/cm and are averaged from three measurements.

### Glass Transition Temperature

The static glass transition temperature is determined via dynamic scanning calorimetry in accordance with DIN 53765. The glass transition temperature T_{g} data relate to the glass transformation temperature value T_{g} in accordance with DIN 53765:1994-03, unless otherwise indicated in the particular case.

### Molecular Weights

The average molecular weight M_{w} and the polydispersity D were determined by means of gel permeation chromatography (GPC). The eluent used was THF with 0.1 vol % trifluoroacetic acid. Measurement took place at 25° C. The preliminary column used was PSS-SDV, 5 μm, 10³ Å (10⁻⁷m), ID 8.0 mm×50 mm. Separation took place using the columns PSS-SDV, 5 μm, 10³ Å (10⁻⁷ m), 105 Å (b 10⁻⁵ m) and 10⁶ Å (10⁻⁴m) each with ID 8.0 mm×300 mm. The sample concentration was 4 g/l, the flow rate 1.0 ml per minute. Measurement took place against PMMA standards.

### Solids Content:

The solids content is a measure of the fraction of unevaporable constituents in a polymer solution. It is determined gravimetrically by weighing the solution, then vaporizing the evaporable fractions in a drying cabinet at 120° C. for 2 hours, and weighing the residue.

### K Value (According to Fikentscher):

The K value is a measure of the average molecule size for high-polymer compounds. For the measurement, one percent strength (1 g/100 ml) toluenic polymer solutions were prepared and their kinematic viscosities were determined with the aid of a Vogel-Ossag viscometer. After standardization to the viscosity of the toluene, the relative viscosity is obtained, from which the K value can be calculated by the method of Fikentscher (polymer 8/1967, 381 ff.).

### Production of Exemplary Adhesive Tapes

### Preparation of the Exemplary Viscoelastic Polymer VP

A reactor conventional for radical polymerizations was charged with 54.4 kg of 2-ethylhexyl acrylate, 20.0 kg of methyl acrylate, 5.6 kg of acrylic acid, and 53.3 kg of acetone/isopropanol (94:6). After nitrogen gas had been passed through the reactor for 45 minutes, with stirring, the reactor was heated to 58° C. and 40 g of AlBN were added. The external heating bath was then heated to 75° C. and the reaction was carried out constantly at this external temperature. After 1 hour a further 40 g of AlBN were added, and after 4 hours dilution took place with 10 kg of acetone/isopropanol mixture (94:6). After a reaction time of 22 hours, the polymerization was discontinued and the batch was cooled to room temperature.

This polymer was then processed further in a hotmelt process by customary methods. In summary, first the solvent was removed under reduced pressure in a concentrating extruder (residual solvent content ≦0.3 wt %) and heating was carried out. In a twin-screw extruder, a crosslinker and accelerator system was added, consisting of pentaerythritol tetraglycidyl ether (Polypox® R16) and triethylenetetramine (Epikure® 925). After compounding, the hotmelt was coated on a process liner, using a two-roll calender.

### Preparation of the Exemplary Pressure-Sensitive Polyacrylate Adhesive PA

A 100 l glass reactor conventional for radical polymerizations was charged with 4.8 kg of acrylic acid, 11.6 kg of butyl acrylate, 23.6 kg of 2-ethylhexyl acrylate, and 26.7 kg of acetone/benzine 60/95 (1:1). After nitrogen gas had been passed through the reactor for 45 minutes, with stirring, the reactor was heated to 58° C. and 30 g of AlBN were added.

The external heating bath was then heated to 75° C. and the reaction was carried out constantly at this external temperature. After a reaction time of 1 hour a further 30 g of AlBN were added. After 4 hours and 8 hours, dilution took place with 10.0 kg each time of acetone/benzine 60/95 (1:1) mixture. After a reaction time of 24 hours, the reaction was discontinued and the batch was cooled to room temperature. The polyacrylate was subsequently blended with Uvacure® 1500, diluted to a solids content of 30% with acetone, and then coated from solution onto a siliconized release film (50 μm polyester) or onto an etched PET film 23 μm thick.

In the text below the invention is to be illustrated in more detail by a number of examples, without thereby wishing to bring about any restriction of whatever kind.

### EXAMPLES

### Example 1

Described by way of example below is a single-layer, carrier-free adhesive tape with bond strength enhanced on one side through plasma treatment. The exemplary adhesive tape consists of a resin-free viscoelastic straight acrylate adhesive, produced by a hotmelt method (by method VP).

The adhesive tape precursor thus produced, with a thickness of 900 μm, lying on a process liner, is subjected after 14 days to a single-side plasma treatment of the open side. The treatment was carried out using a Plasmatreat FG5001 laboratory unit with a RD1004 rotary nozzle, using compressed air, with a distance of 10 m/min at a 10 mm distance from the substrate.

Test strips 20 mm in breadth and 25 cm long were subsequently cut and were subjected to bond strength testing on steel by method 1. The bond strength of the open, plasma-treated side was 40 N/cm, and the adhesive failed cohesively in testing. The bond strength of the lined, untreated side was 17 N/cm. This corresponds to a ratio of 2.35, in other words to an enhancement or graduation by 135%.

### Example 2

An adhesive tape precursor is produced as in example 1. The adhesive tape precursor is subjected to corona treatment (DBD in air, Vetaphone) of the open side with a dose of 33 Wmin/m². Test strips 20 mm in breadth and 25 cm long were subsequently cut and were subjected to bond strength testing on steel by method 1. The bond strength of the open, corona-treated side was 27 N/cm, and the adhesive failed adhesively in testing. The bond strength of the lined, untreated side was 17 N/cm. This corresponds to an enhancement or graduation by 58%.

### Example 3

An adhesive tape precursor is produced as in example 1. The adhesive tape precursor is subjected to plasma treatment (DBD, Vetaphone) in an N₂ atmosphere of the open side with a dose of 33 Wmin/m². Test strips 20 mm in breadth and 25 cm long were subsequently cut and were subjected to bond strength testing on steel by method 1. The bond strength of the open, corona-treated side was 21 N/cm, and the adhesive failed adhesively in testing. The bond strength of the lined, untreated side was 17 N/cm. This corresponds to an enhancement or graduation by 23%.

### Example 4

Even in the case of high polar straight acrylate PSAs, surprisingly, from solvent coating, a further increase in the bond strength by a physical treatment can be observed. The exemplary adhesive has a copolymerized acrylic acid fraction of 12%, and nevertheless a further introduction of polar groups by means of a physical treatment is able to boost the bond strength.

After coating onto PET film (by method PA, coatweight 50 g/m²), the adhesive is subjected on the open side to a corona treatment in air, with a dose of 33 Wmin/m². Following the treatment, the open, treated side has a bond strength to steel by method 1 of 12.6 N/cm. The lined, untreated side has a bond strength of 9.1 N/cm. This corresponds to an enhancement of 38%.

### Example 5

Surprisingly, the physical treatment also increases the bond strength to polyethylene (PE). By way of example, a PE-based foam from Alveo (400 μm, closed-cell, corona-treated) was used. For this substrate the bond strength was measured by method 2.

Following treatment of the adhesive (adhesive tape from example 4) with air corona, with a dose of 66 Wmin/m², the bond strength was increased relative to the PE-based substrate by 40%. The bond strength was increased by 80% by means of plasma treatment in an N₂ atmosphere (DBD, Vetaphone).

Even in the case of an adhesive with resin blending, surprisingly, an increase in the bond strength through a physical pretreatment was obtained. For this purpose, a resin-blended acrylate adhesive (1 wt. % acrylic acid, 40 wt. % hydrocarbon resin) was coated onto PET film (20 g/m²) and treated by air corona (66 Wmin/m²). The treatment resulted in a 25% increase in the bond strength as measured relative to the PE-based substrate.

### Example 6

A particularly surprising observation was the long-term-stable increase in bond strength between two acrylate adhesives. This is observed when a viscoelastic straight acrylate core (900 μm, from example 1) is treated with N₂ plasma (DBD, Vetaphone), and a PSA (50 g/m², from example 2) is treated by air corona. After different storage times, the adhesives were laminated together, lined on the back with an etched PET film, then subjected to measurement of the bond strength between the layers, by method 2. After 7 and also after 30 days of storage time after treatment of the respective adhesives, on silicone liners, the bond strength obtained is at least 95% of the immediate value (increase in the bond strength to 300% in comparison to without treatment). The functional groups generated as a result of the physical treatment, which contribute to the increase in the bond strength, are therefore demonstrably still present in the interface and have long-term stability. This is a particularly unusual observation, since the effect of a corona treatment typically declines within days.

1. A method for increasing the bond strength of a layer of pressure-sensitive adhesive (PSA) having a top and a bottom surface, said method comprising subjecting the PSA layer at least on one surface side to a physical method, the physical method being selected from the group consisting of corona discharge, dielectric barrier discharge, flame pretreatment, and plasma treatment.

2. The method as claimed in claim 1,
wherein
the physical method is conducted in a treatment atmosphere formed by the following pure or mixtures of process gases: N₂, O₂, H₂, CO₂, Ar, He, ammonia, and ethylene, it also being possible for steam or other volatile constituents to have been added.

3. The method as claimed in claim 2,
wherein
the physical method takes place at or near to atmospheric pressure.

4. The method as claimed in claim 2,
wherein
reactive aerosols are present in or added to the treatment atmosphere.

5. The method as claimed in claim 1,
wherein
both surfaces of the PSA layer are subjected to a physical method.

6. The method as claimed in claim 1,
wherein
both surfaces of the PSA layer are subjected to a physical method in such a way as to produce unequal bond strengths on the two sides.

7. The method as claimed in claim 1,
wherein
the physical method is a plasma treatment at or near to atmospheric pressure.

8. The method as claimed in claim 1,
wherein
PSA layer is based on natural rubber, synthetic rubber, polyurethanes, or acrylate.

9. The method as claimed in claim 1,
wherein
the substrate to which the PSA layer is to be bonded has been physically pretreated.

10. A method for producing an adhesive tape, the method comprising applying adhesive to a carrier, and increasing the bond strength by subjecting one free surface to a physical method, the physical method being selected from the group consisting of corona discharge, dielectric barrier discharge, and plasma treatment.
